(19) United States
(12) Patent Application Publication
(10) Pub. No.: US 2024/0123527 A1
(43) Pub. Date: Apr. 18, 2024

(54) DRY-CUT RAIL SAW WITH INTEGRATED DUST COLLECTION

(71) Applicant: JPL GLOBAL, LLC, Perris, CA (US)

(72) Inventor: Paul W. Guth, Menifee, CA (US)

(21) Appl. No.: 18/488,988

(22) Filed: Oct. 17, 2023

Related U.S. Application Data
(60) Provisional application No. 63/416,878, filed on Oct. 17, 2022.

(51) Int. Cl. B23D 59/00; B23D 45/02; B23Q 11/08

(52) U.S. Cl. CPC B23D 59/006; B23D 45/024; B23Q 11/085

(57) ABSTRACT

Various aspects of a saw apparatus include a worktable, a cutting head that includes a circular saw blade, and a vacuum source. In a first aspect, the cutting head moves along a rail, and the vacuum source provides a negative pressure region beneath a trolley that moves along the worktable such that a center slot remains axially aligned with the circular saw blade. In a second aspect, the cutting head moves along a rail, and a dust guard is coupled to the circular saw blade. The vacuum source provides a negative pressure region above the worktable. In another aspect, the cutting head moves along a rail, and the vacuum source provides a negative pressure region beneath a trolley that is coupled with the cutting head via a pulley system that maintains an alignment between the cutting head and the trolley as the cutting head moves along the rail.

### CROSS-REFERENCE TO RELATED APPLICATIONS

This application claims the benefit of U.S. Provisional Patent Application Ser. No. 63/416,878, filed Oct. 17, 2022, which is titled “DRY-CUT RAIL SAW WITH INTEGRATED DUST COLLECTION” and its entire contents of which are incorporated herein by reference.

### TECHNICAL FIELD

The subject disclosure generally relates to dust collection, and more specifically to integrating a dust collection system within a dry-cut rail saw apparatus.

### BACKGROUND

Conventional rail saws for cutting stone slabs and tile use a spray of water onto the diamond cutting blade and onto the stone slab and tile material for cooling the blade and suppressing the dust. This supply of water, however, creates several problems. For instance, using water can stain stone slabs and some tile materials being cut. Also, conventional stone slab and tile rail saws typically have a tub or pan of water with a pump that supplies water to the cutting head. During cutting, the water is sprayed and dispersed around the rail saw cutting area. Many attempts at containing such water with extension trays and spray guards to contain this water and attempting to return it to the supply pan have been made with less than perfect results. Because this water can drip, spray, and potentially spill it means you cannot always put the stone slab and or tile rail saw near where the actual stone slab and/or tile installation is taking place. The user is thus forced to spend a significant amount of time walking back and forth between the rail saw and the stone slab and/or tile installation area.

Accordingly, a dry-operated rail saw which prevents dust from escaping into the environment is desirable. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with a dust collection system. In one such aspect, a saw apparatus to facilitate dust collection is disclosed. Within such embodiment, the saw apparatus includes a worktable and a cutting head that includes a circular saw blade in which the cutting head is configured to move along a rail. The apparatus further includes a trolley that includes a center slot and is configured to move along the worktable such that the center slot is configured to remain axially aligned with the circular saw blade as the cutting head moves along the rail. For this embodiment, a vacuum source coupled to the trolley is also included, which is configured to provide a negative pressure region beneath the trolley at the center slot.

In a further aspect, another saw apparatus to facilitate dust collection is disclosed. For this embodiment, the saw apparatus includes a worktable and a cutting head that includes a circular saw blade in which the cutting head is configured to move along a rail positioned above the worktable. The apparatus further includes a dust guard coupled to the circular saw blade, and a vacuum source coupled to the dust guard. Here, the vacuum source is configured to provide a negative pressure region above the worktable and proximate to an anticipated point of contact between the circular saw blade and a workpiece.

In yet another aspect, saw apparatus to facilitate dust collection is again disclosed. For this embodiment, the saw apparatus includes a worktable and a cutting head that includes a circular saw blade in which the cutting head is configured to move along a rail positioned above the worktable. The apparatus further includes a trolley coupled with the cutting head via a pulley system configured to maintain an alignment between the cutting head and the trolley as the cutting head moves along the rail. The apparatus also includes a vacuum source coupled to the trolley in which the vacuum source is configured to provide a negative pressure region beneath the trolley and proximate to an anticipated point of contact between the circular saw blade and a workpiece.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 is a block diagram of an exemplary rail saw apparatus that facilitates removing airborne dust in accordance with an aspect of the subject specification;

FIG. 2 is a schematic illustrating a first view of an exemplary rail saw apparatus that facilitates removing airborne dust in accordance with an aspect of the subject specification;

FIG. 3 is a schematic illustrating a second view of an exemplary rail saw apparatus that facilitates removing airborne dust in accordance with an aspect of the subject specification;

FIG. 4 is a schematic illustrating an exemplary trolley coupled to a worktable in accordance with an aspect of the subject specification;

FIG. 5 is a schematic illustrating an exemplary trolley in accordance with an aspect of the subject specification;

FIG. 6 is a schematic illustrating a first view of an exemplary tilt mechanism in accordance with an aspect of the subject specification;

FIG. 7 is a schematic illustrating a second view of an exemplary tilt mechanism in accordance with an aspect of the subject specification;

FIG. 8 is a schematic illustrating a first view of an exemplary dust guard that facilitates providing an upper vacuum chamber in accordance with an aspect of the subject specification;

FIG. 9 is a schematic illustrating a second view of an exemplary dust guard that facilitates providing an upper vacuum chamber in accordance with an aspect of the subject specification;

FIG. 10 is a schematic illustrating a third view of an exemplary dust guard that facilitates providing an upper vacuum chamber in accordance with an aspect of the subject specification; and

FIG. 11 is a schematic illustrating a fourth view of an exemplary dust guard that facilitates providing an upper vacuum chamber in accordance with an aspect of the subject specification.

### DETAILED DESCRIPTION

### Overview

The various embodiments disclosed herein are directed toward integrating a dust collection system within a dry-cut rail saw apparatus. Such aspects include aspects directed toward a stone slab and/or tile rail saw with a fully integrated dust collection and filtration system.

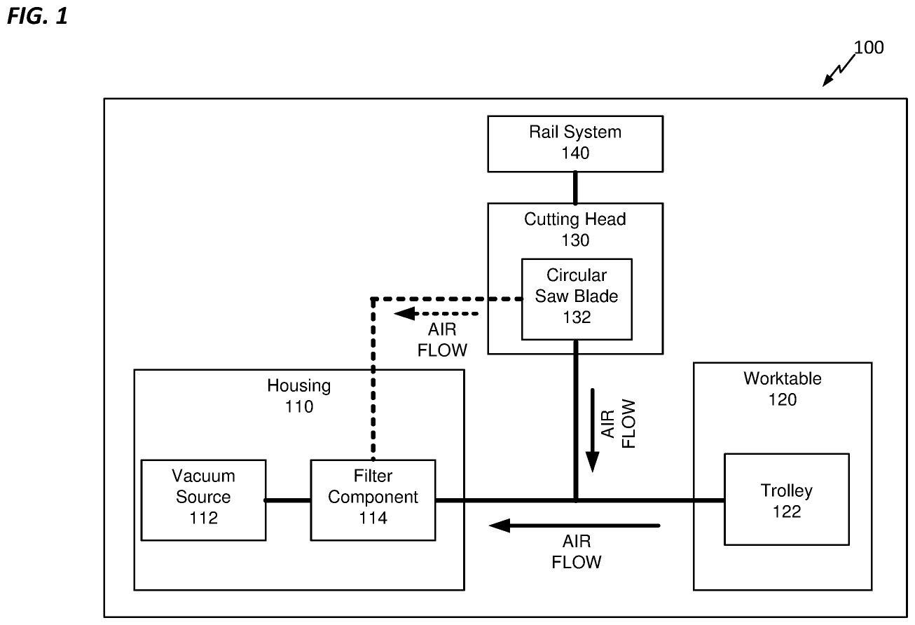

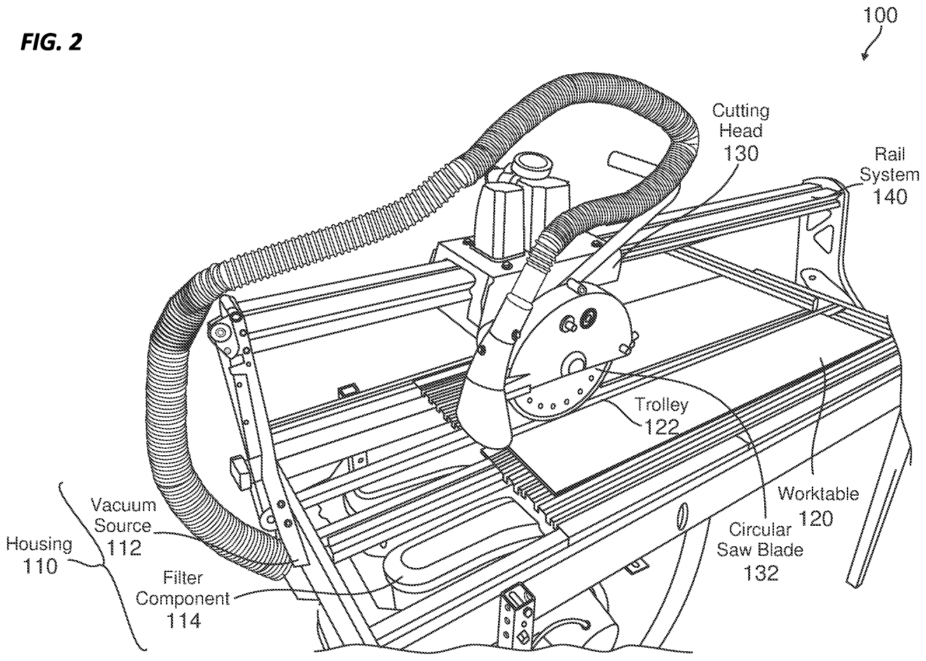

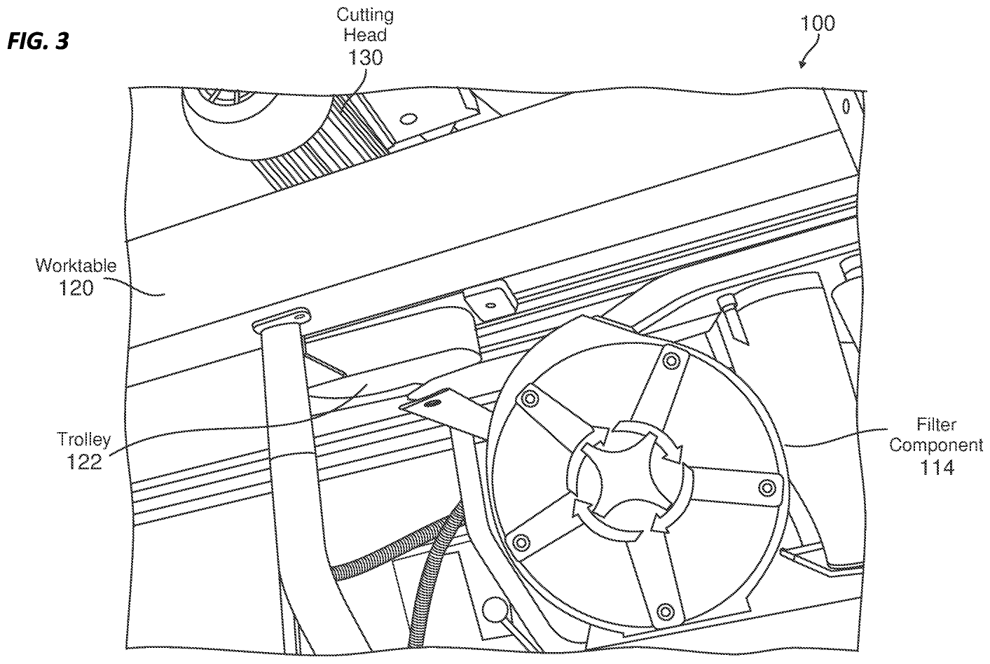

In FIG. 1, a block diagram is provided of an exemplary dry-cut rail saw apparatus that facilitates removing airborne dust in accordance with an aspect of the subject specification. As illustrated, rail saw apparatus 100 comprises a housing 110, a worktable 120, a cutting head 130, and a rail system 140. For this embodiment, housing 110 may further comprise a vacuum source 112 and a filter 114, whereas worktable 120 may comprise a trolley 122, and cutting head 130 may comprise a circular saw blade 132. As illustrated in FIGS. 2-3, it is contemplated that cutting head 130 may be configured to move along a rail system 140, and that trolley 122 may comprise a center slot and be configured to move along the worktable 120, wherein the center slot is configured to remain axially aligned with circular saw blade 132 as the cutting head 130 moves along the rail system 140. During use, vacuum source 112 is configured to provide a negative pressure beneath trolley 122 at the center slot.

Various aspects of the rail saw apparatus 100 are contemplated and disclosed herein. For instance, various aspects directed towards trolley 122 are contemplated. In another aspect, a tilt mechanism is contemplated to facilitate making angled cuts. In yet another aspect, a dust guard configuration is contemplated to facilitate providing a second negative pressure region above worktable 110 and proximate to circular saw blade 132.

### Exemplary Trolley Embodiments

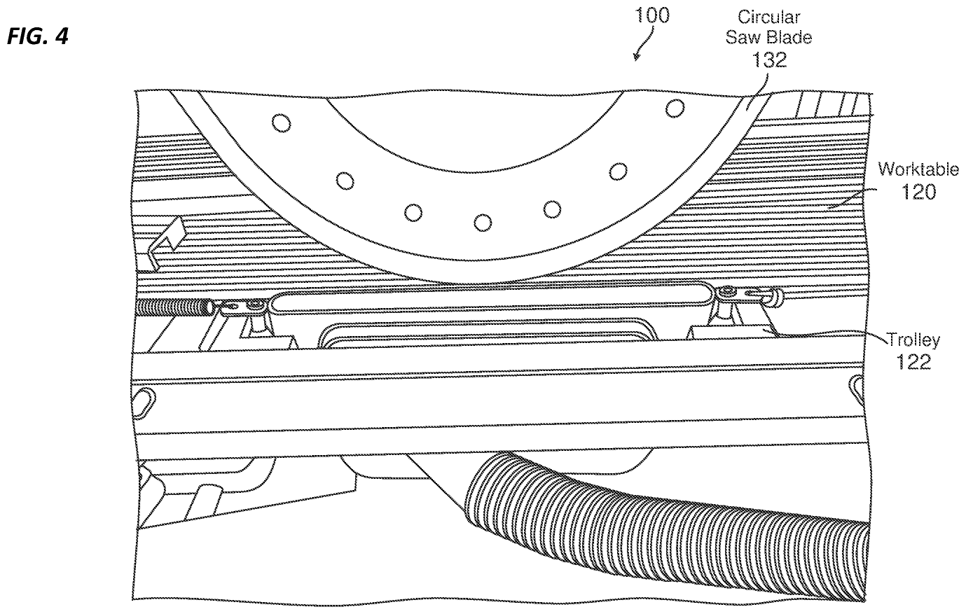

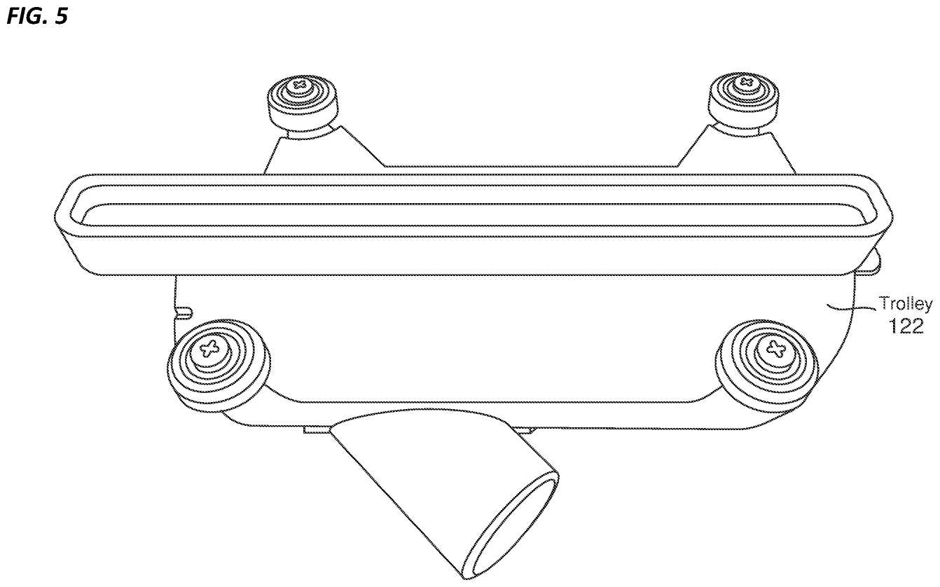

In a first exemplary embodiment, it is contemplated that trolley 122 may be configured to roll on worktable 120 immediately below circular saw blade 132. For instance, as illustrated in FIGS. 4-5, worktable 120 may include a trolley track, wherein rollers on trolley 122 may be configured to roll on the trolley track. To maintain an alignment between cutting head 130 and trolley 122 as cutting head 130 moves along the rail system 140, it is further contemplated that cutting head 130 and trolley 122 may be coupled via a pulley system (e.g., comprising springs and cables). As illustrated, trolley 122 may comprise a vacuum port which may be configured to connect to vacuum source 112 via a vacuum hose. During use, vacuum source 112 creates a vacuum chamber (i.e., a dust collection chamber) within trolley 122 immediately below the center slot, wherein the vacuum chamber follows the movement and position of circular saw blade 132. As a result, airborne dust from a material cut by circular saw blade 132 is drawn into the vacuum chamber and towards filter component 114. Here, it should be appreciated that filter component 114 may comprise a multi-stage filter of different filter types (e.g., where airborne dust first passes through a set of cyclonic filters and then a cylindrical filter).

### Exemplary Tilt Mechanism Embodiments

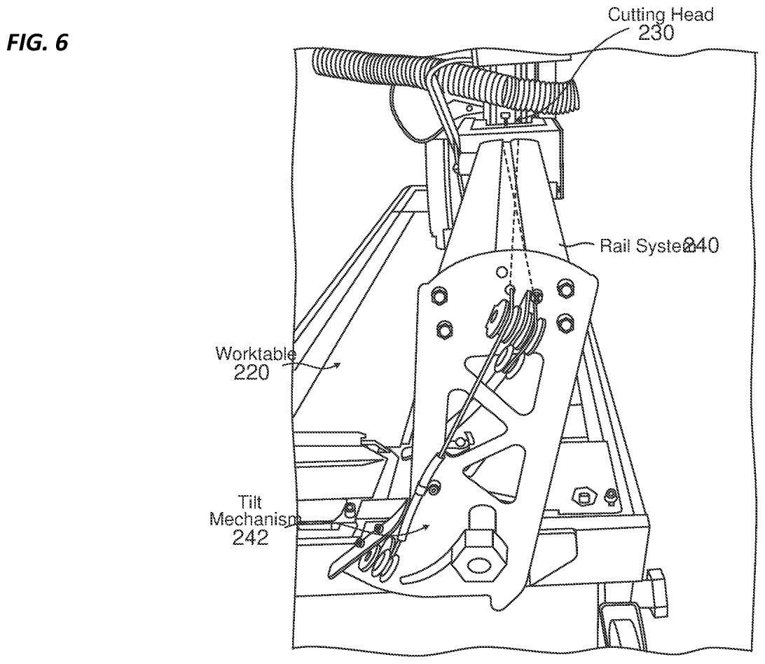

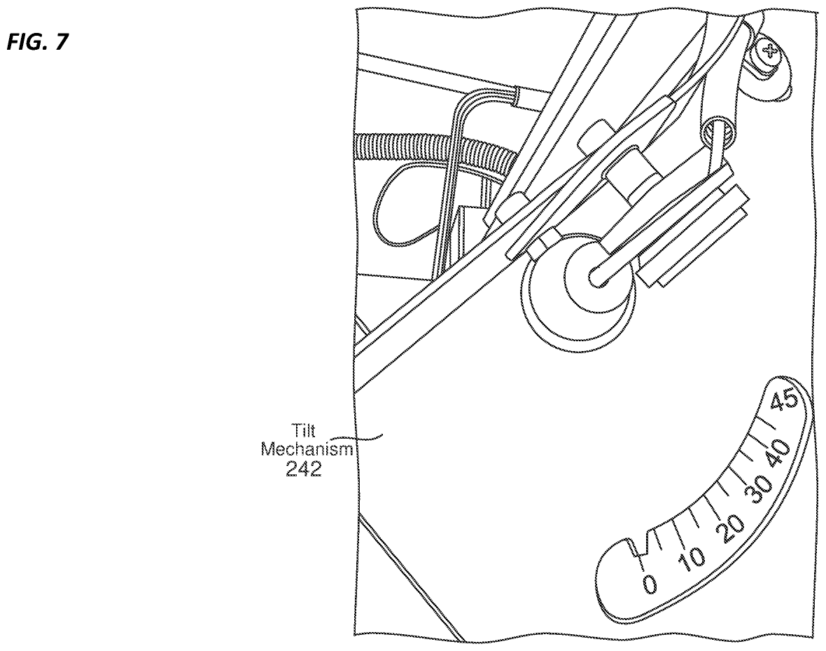

Referring next to FIGS. 6-7, schematics are provided respectively illustrating a first and second view of an exemplary tilt mechanism in accordance with an aspect of the subject specification. Here, it should be appreciated that rail saw apparatus 200 is substantially similar to rail saw apparatus 100, wherein worktable 220 is substantially similar to worktable 120, and wherein cutting head 230 is substantially similar to cutting head 130. Rail system 240 is also substantially similar to rail system 140, however, rail system 240 further comprises a tilt mechanism 242, as shown. Within such embodiment, tilt mechanism 242 is configured to facilitate angled cuts by pivoting rail system 240 about a pivot point. As illustrated, tilt mechanism 242 may comprise a knob to facilitate pivoting rail system 240 so as to lock the cutting head into a plurality of tilt angles (e.g., up to 45 degrees).

### Exemplary Upper Vacuum Embodiments

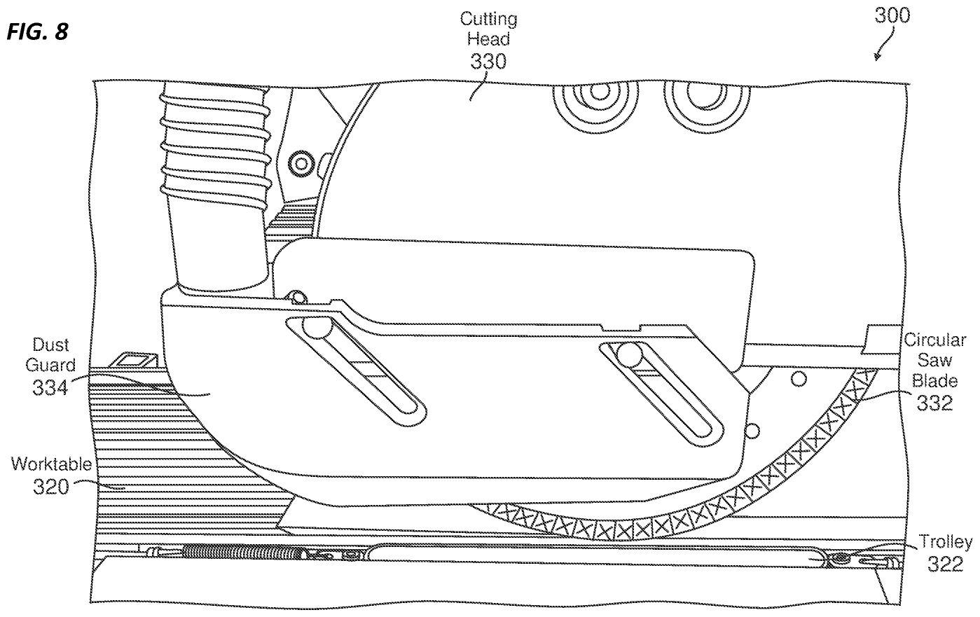

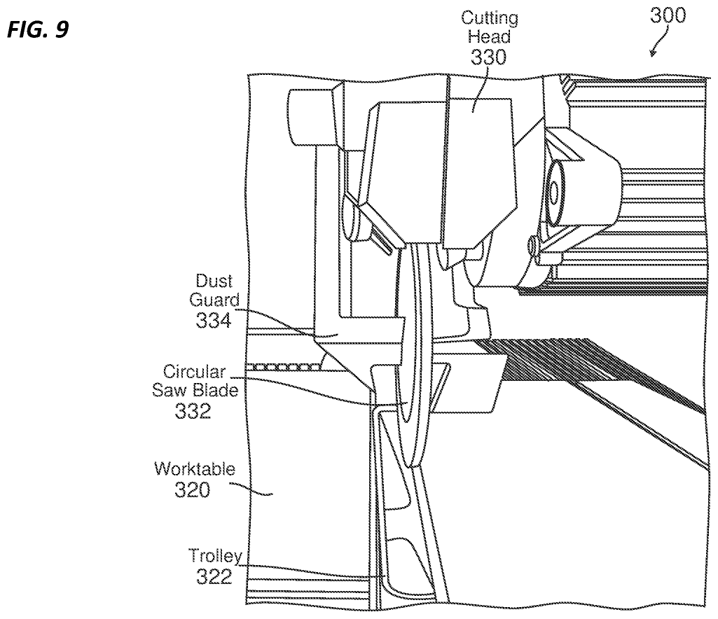

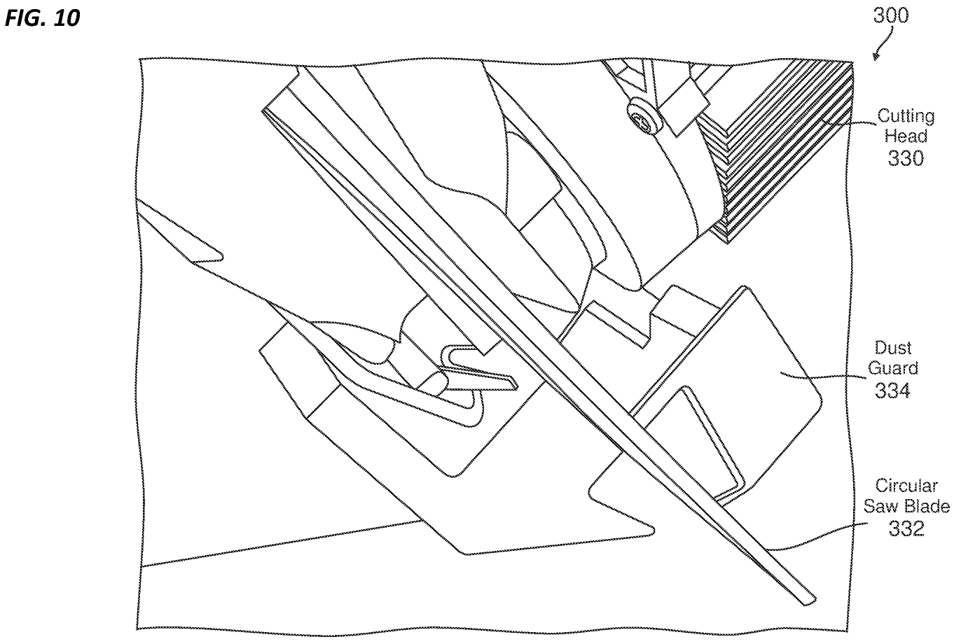

Referring next to FIGS. 8-11, schematics are provided respectively illustrating various views of an exemplary dust guard that facilitates providing an upper vacuum chamber in accordance with an aspect of the subject specification. Here, it should be appreciated that rail saw apparatus 300 is substantially similar to rail saw apparatus 100 and 200, wherein worktable 320 is substantially similar to worktable 120 and 220, and wherein cutting head 330 is substantially similar to cutting head 130 and 230.

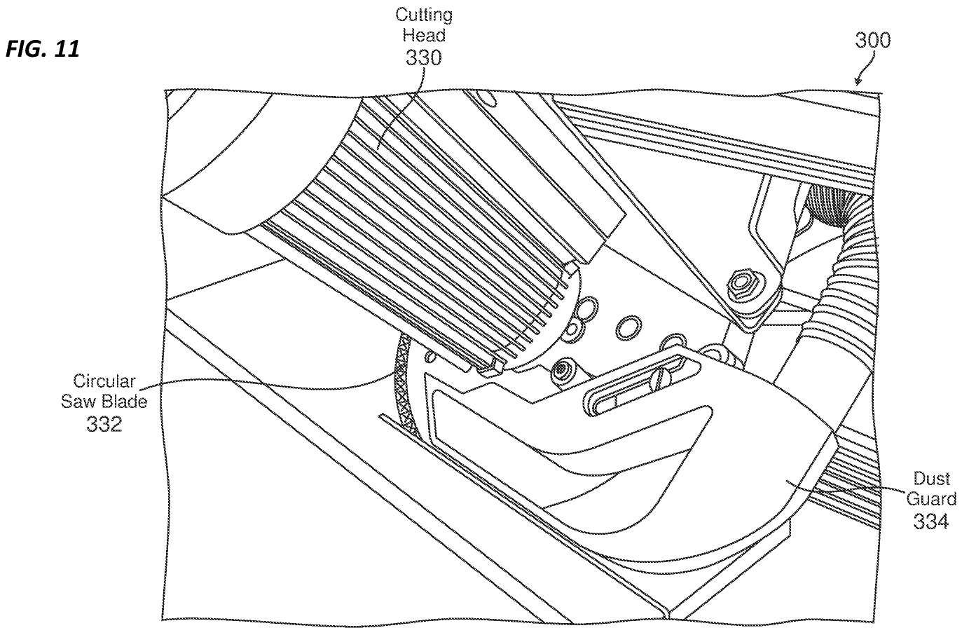

As illustrated, dust guard 334 may be configured to attach to both sides of circular saw blade 332 so as to create a vacuum chamber above worktable 320 and proximate to an anticipated point of contact between the circular saw blade 332 and a workpiece. Dust guard 334 may, for example, include a vacuum port that connects dust guard 334 to vacuum source 112 via a vacuum hose, as shown in FIG. 11. Within such embodiment, airborne dust from cutting material with circular saw blade 332 is collected above worktable 320 via the upper vacuum chamber facilitated by dust guard 334, and below worktable 320 via the lower vacuum chamber facilitated by trolley 322.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

1. A saw apparatus comprising:
a worktable;
a cutting head comprising a circular saw blade, wherein the cutting head is configured to move along a rail;
a trolley comprising a center slot and configured to move along the worktable, wherein the center slot is configured to remain axially aligned with the circular saw blade as the cutting head moves along the rail; and
a vacuum source coupled to the trolley, wherein the vacuum source is configured to provide a negative pressure region beneath the trolley at the center slot.

2. The saw apparatus of claim 1, wherein the cutting head and the trolley are coupled via a pulley system, and wherein the pulley system is configured to maintain an alignment between the cutting head and the trolley as the cutting head moves along the rail.

3. The saw apparatus of claim 1, wherein the cutting head is configured to tilt to facilitate angled cuts.

4. The saw apparatus of claim 3, wherein the cutting head is configured to tilt up to 45 degrees relative to the worktable.

5. The saw apparatus of claim 3, wherein the cutting head is configured to lock into a plurality of tilt angles.

6. The saw apparatus of claim 1, further comprising a dust guard coupled to the circular saw blade and the vacuum source, wherein the vacuum source is configured to provide a second negative pressure region above the worktable and proximate to an anticipated point of contact between the circular saw blade and a workpiece.

7. The saw apparatus of claim 6, wherein the dust guard is comprised of flexible material.

8. The saw apparatus of claim 6, wherein the dust guard comprises a view window.

9. The saw apparatus of claim 1, further comprising a filter component coupled to the vacuum source.

10. A saw apparatus comprising:
a worktable;
a cutting head comprising a circular saw blade, wherein the cutting head is configured to move along a rail positioned above the worktable;
a dust guard coupled to the circular saw blade; and
a vacuum source coupled to the dust guard, wherein the vacuum source is configured to provide a negative pressure region above the worktable and proximate to an anticipated point of contact between the circular saw blade and a workpiece.

11. The saw apparatus of claim 10, wherein the vacuum source is configured to provide a second negative pressure region beneath the worktable and proximate to the anticipated point of contact between the circular saw blade and the workpiece.

12. The saw apparatus of claim 11, wherein the second negative pressure region beneath the worktable is configured to remain axially aligned with the circular saw blade as the cutting head moves along the rail.

13. The saw apparatus of claim 10, wherein the cutting head is configured to tilt to facilitate angled cuts.

14. The saw apparatus of claim 13, wherein the cutting head is configured to tilt up to 45 degrees relative to the worktable.

15. The saw apparatus of claim 13, wherein the cutting head is configured to lock into a plurality of tilt angles.

16. A saw apparatus comprising:
a worktable;
a cutting head comprising a circular saw blade, wherein the cutting head is configured to move along a rail positioned above the worktable;
a trolley coupled with the cutting head via a pulley system, wherein the pulley system is configured to maintain an alignment between the cutting head and the trolley as the cutting head moves along the rail; and
a vacuum source coupled to the trolley, wherein the vacuum source is configured to provide a negative pressure region beneath the trolley and proximate to an anticipated point of contact between the circular saw blade and a workpiece.

17. The saw apparatus of claim 16, further comprising a dust guard coupled to the circular saw blade and the vacuum source, wherein the vacuum source is configured to provide a second negative pressure region above the worktable and proximate to the anticipated point of contact between the circular saw blade and the workpiece.

18. The saw apparatus of claim 16, wherein the pulley system is configured to tilt to facilitate angled cuts.

19. The saw apparatus of claim 18, wherein the pulley system is configured to tilt up to 45 degrees relative to the worktable.

20. The saw apparatus of claim 18, wherein the pulley system is configured to lock into a plurality of tilt angles.
